(19) United States
(12) Patent Application Publication
(10) Pub. No.: US 2024/0080490 A1
(43) Pub. Date: Mar. 7, 2024

(54) SIGNALING FOR MULTI-REFERENCE LINE PREDICTION AND MULTI-HYPOTHESIS PREDICTION

(71) Applicant: HFI Innovation Inc., Zhubei City (TW)

(72) Inventors: Man-Shu Chiang, Hsinchu City (TW); Chih-Wei Hsu, Hsinchu City (TW); Ching-Yeh Chen, Hsinchu City (TW)

(73) Assignee: HFI Innovation Inc., Zhubei City (TW)

(21) Appl. No.: 18/506,868

(22) Filed: Nov. 10, 2023

Related U.S. Application Data
(63) Continuation of application No. 16/691,454, filed on Nov. 21, 2019.
(60) Provisional application No. 62/770,869, filed on Nov. 23, 2018.

(51) Int. Cl. H04N 19/70; H04N 19/103; H04N 19/159; H04N 19/176; H04N 19/182

(52) U.S. Cl. CPC H04N 19/70; H04N 19/103; H04N 19/159; H04N 19/176; H04N 19/182

(57) ABSTRACT

A video codec receives data for a block of pixels to be encoded or decoded as a current block of a current picture of a video. The video codec signals or parses a first syntax element for a first coding mode in a particular set of two or more coding modes. Each of coding mode of the particular set of coding modes modifies a merge candidate or an inter-prediction that is generated based on the merge candidate. The video codec enables the first coding mode and disables one or more other coding modes in the particular set of coding modes. The disabled one or more coding modes in the particular set of coding modes are disabled without parsing syntax elements for the disabled coding modes. The video codec encodes or decodes the current block by using the enabled first coding mode and bypassing the disabled coding modes.

### CROSS REFERENCE TO RELATED PATENT APPLICATION(S)

The present disclosure is a continuation of and claim priority to U.S. Non-Provisional patent application Ser. No. 16/691,454, filed on Nov. 21, 2019, which claims the priority benefit of U.S. Provisional Patent Application No. 62/770,869, filed on Nov. 23, 2018. Content of above-listed application is herein incorporated by reference.

### TECHNICAL FIELD

The present disclosure relates generally to video processing. In particular, the present disclosure relates to methods of signaling coding modes.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block, and each CU can be recursively split into four smaller CUs until the predefined minimum size is reached. Each CU contains one or multiple prediction units (PUs).

To achieve the best coding efficiency of hybrid coding architecture in HEVC, there are two kinds of prediction modes for each PU, which are intra prediction and inter prediction. For intra prediction modes, the spatial neighboring reconstructed pixels can be used to generate the directional predictions. There are up to 35 directions in HEVC. For inter prediction modes, the temporal reconstructed reference frames can be used to generate motion compensated predictions. There are three different modes, including Skip, Merge and Inter Advanced Motion Vector Prediction (AMVP) modes.

When a PU is coded in Inter AMVP mode, motion-compensated prediction is performed with transmitted motion vector differences (MVDs) that can be used together with Motion Vector Predictors (MVPs) for deriving motion vectors (MVs). To decide MVP in Inter AMVP mode, the advanced motion vector prediction (AMVP) scheme is used to select a motion vector predictor among an AMVP candidate set including two spatial MVPs and one temporal MVP. So, in AMVP mode, MVP index for MVP and the corresponding MVDs are required to be encoded and transmitted. In addition, the inter prediction direction to specify the prediction directions among bi-prediction, and uni-prediction which are list 0 (L0) and list 1 (L1), accompanied with the reference frame index for each list should also be encoded and transmitted.

When a PU is coded in either Skip or Merge mode, no motion information is transmitted except the Merge index of the selected candidate. That is because the Skip and Merge modes utilize motion inference methods (MV=MVP+MVD where MVD is zero) to obtain the motion information from spatially neighboring blocks (spatial candidates) or a temporal block (temporal candidate) located in a co-located picture where the co-located picture is the first reference picture in list 0 or list 1, which is signaled in the slice header. In the case of a Skip PU, the residual signal is also omitted. To determine the Merge index for the Skip and Merge modes, the Merge scheme is used to select a motion vector predictor among a Merge candidate set containing four spatial MVPs and one temporal MVP.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for efficiently signaling syntax elements for coding modes or tools. In some embodiments, a video codec (encoder or decoder) receives data for a block of pixels to be encoded or decoded as a current block of a current picture of a video. The video codec signals or receives a first syntax element for a first coding mode in a particular set of two or more coding modes. Each of coding mode of the particular set of coding modes modifies a merge candidate or an inter-prediction that is generated based on the merge candidate. The video codec enables the first coding mode. The video codec also disables one or more other coding modes in the particular set of coding modes without signaling or parsing syntax elements for the disabled one or more coding modes. In some embodiments, the disabled one or more other coding modes in the particular set of coding modes are inferred to be disabled based on the first syntax element. The video codec encodes or decodes the current block by using the enabled first coding mode and bypassing the disabled coding modes.

Aspects of the disclosure provide an electronic apparatus including a video encoder circuit. The video encoder circuit perform operations including determining data for a block of pixels to be encoded as a current block of a current picture of a video. The data includes a first syntax element to indicate whether multiple-hypothesis (MH) mode is enabled for the current block. The operations further include generating a first hypothesis of prediction for the current block using a first candidate. In response to the first syntax indicating that the MH mode is enabled for the current block, the operations include determining a second candidate according to a second syntax element to be signaled, generating a second hypothesis of prediction for the current block using the second candidate, combining the first and second hypotheses of prediction to form a combined prediction, and encoding the current block using the first hypothesis of prediction or a combined prediction. The first candidate refers to a first inter merge candidate selected from a merge candidate list. In response to determining the second candidate as an intra prediction mode, the intra prediction mode is inferred as planar without signaling. In response to determining the second candidate as a second inter merge candidate, the second inter merge candidate is selected from a subset of the merge candidate list.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the MVP candidates set for inter-prediction modes.

FIG. 2 illustrates a merge candidates list that includes combined bi-predictive merge candidates.

FIG. 3 illustrates a merge candidates list that includes scaled merge candidates.

FIG. 4 illustrates an example in which zero vector candidates are added to a merge candidates list or an AMVP candidates list.

FIG. 5 shows the intra-prediction modes in different directions. These intra-prediction modes are referred to as directional modes and do not include DC mode or Planar mode.

FIG. 6 conceptually illustrates multi-reference line intra prediction (MRLP) for an example PU.

FIG. 7 illustrates extended merge candidate under MMVD or UMVE.

FIGS. 8a-b conceptually illustrate encoding or decoding a block of pixels by using MH Mode for Intra and MH Mode Inter.

FIG. 9 conceptually illustrates a CU that is coded by TPM.

FIG. 10 illustrates an example video encoder that efficiently signal syntax element for coding modes or tools.

FIG. 11 illustrates portions of the video encoder that implement efficient signaling of coding modes or tools.

FIG. 12 conceptually illustrates a process for efficiently signaling syntax elements for coding modes or tools by a video encoder.

FIG. 13 illustrates an example video decoder that implement efficient signaling of coding modes or tools.

FIG. 14 illustrates portions of the video decoder that implement efficient signaling of coding modes or tools.

FIG. 15 conceptually illustrates a process for efficiently signaling syntax elements for coding modes or tools by a video decoder.

FIG. 16 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Inter-Prediction Modes

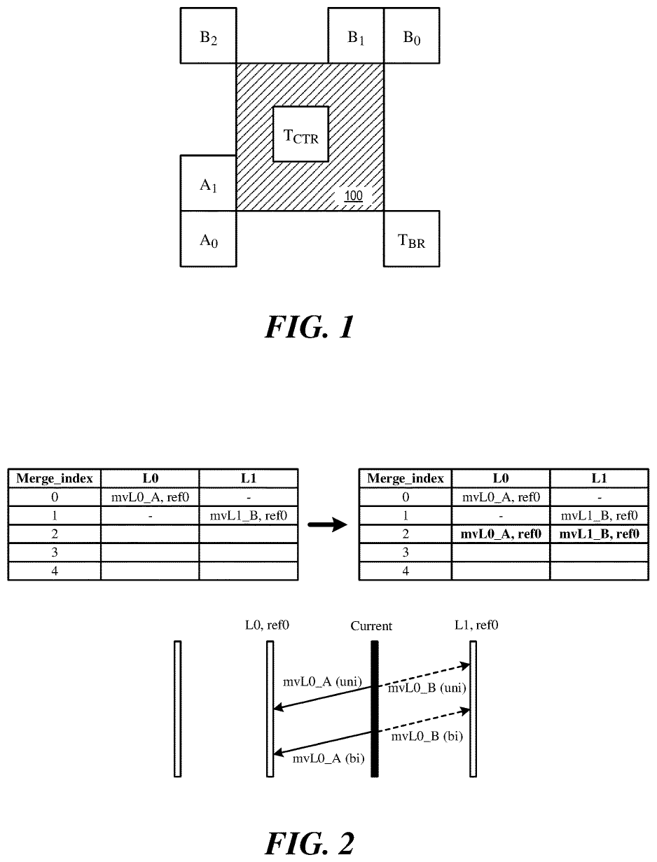

FIG. 1 shows the MVP candidates set for inter-prediction modes in HEVC (i.e., skip, merge, and AMVP). The figure shows a current block 100 of a video picture or frame being encoded or decoded. The current block 100 (which can be a PU or a CU) refers to neighboring blocks to derive the spatial and temporal MVPs for AMVP mode, merge mode or skip mode.

For skip mode and merge mode, up to four spatial merge indices are derived from A₀, A₁, B₀ and B₁, and one temporal merge index is derived from T_{BR} or T_{CTR} (T_{BR} is used first, if T_{BR} is not available, T_{CTR} is used instead). If any of the four spatial merge index is not available, the position B₂ is used to derive merge index as a replacement. After the deriving four spatial merge indices and one temporal merge index, redundant merge indices are removed. If the number of non-redundant merge indices is less than five, additional candidates may be derived from original candidates and added to the candidates list. There are three types of derived candidates:
1. Combined bi-predictive merge candidate (derived candidate type 1)
2. Scaled bi-predictive merge candidate (derived candidate type 2)
3. Zero vector merge/AMVP candidate (derived candidate type 3)

For derived candidate type 1, combined bi-predictive merge candidates are created by combining original merge candidates. Specifically, if the current slice is a B slice, a further merge candidate can be generated by combining candidates from List 0 and List 1. FIG. 2 illustrates a merge candidates list that includes combined bi-predictive merge candidates. As illustrated, two original candidates having mvL0 (the motion vector in list 0) and refIdxL0 (the reference picture index in list 0) or mvL1 (the motion vector in list 1) and refIdxL1 (the reference picture index in list 1), are used to create bi-predictive Merge candidates.

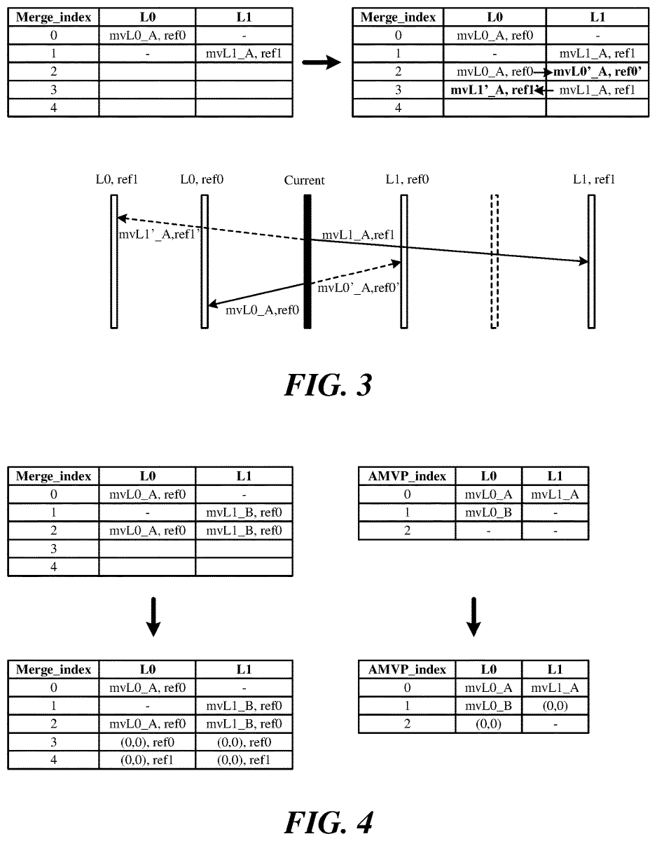

For derived candidate type 2, scaled merge candidates are created by scaling original merge candidates. FIG. 3 illustrates a merge candidates list that includes scaled merge candidates. As illustrated, an original merge candidate has mvLX (the motion vector in list X, X can be 0 or 1) and refIdxLX (the reference picture index in list X, X can be 0 or 1). For example, an original candidate A is a list 0 uni-predicted MV with mvL0_A and reference picture index ref0. Candidate A is initially copied to list L1 as having reference picture index ref0′. The scaled MV mvL0′_A is calculated by scaling mvL0_A based on ref0 and ref0′. A scaled bi-predictive Merge candidate having mvL0_A and ref0 in list L0 and mvL0′_A and ref0′ in list L1 is created and added to the merge candidates list. Likewise, a scaled bi-predictive merge candidate which has mvL1′_A and ref1′ in List 0 and mvL1′_A, ref1 in List 1 is created and added to the merge candidates list.

For derived candidate type 3, zero vector candidates are created by combining zero vectors and reference indices. If a created zero vector candidate is not a duplicate, it is added to the merge/AMVP candidates list. FIG. 4 illustrates an example in which zero vector candidates are added to a merge candidates list or an AMVP candidates list.

### II. Intra-Prediction Mode

Intra-prediction method exploits one reference tier adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

When a PU is coded in Intra mode, pulse code modulation (PCM) mode or intra mode can be used. In PCM mode, the prediction, transform, quantization and entropy coding are bypassed, and the samples are directly represented by a pre-defined number of bits. Its main purpose is to avoid excessive consumption of bits when the signal characteristics are extremely unusual and cannot be properly handled by hybrid coding (e.g., noise-like signals). In intra mode, traditionally, the intra prediction method only exploits one reference tier adjacent to the current prediction unit (PU) and one of the intra prediction modes to generate the predictors for the current PU.

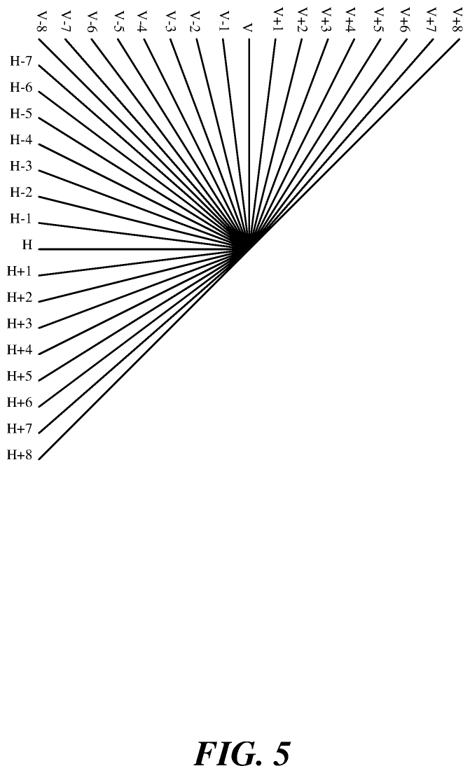

FIG. 5 shows the intra-prediction modes in different directions. These intra-prediction modes are referred to as directional modes and do not include DC mode or Planar mode. As illustrated, there are 33 directional modes (V: vertical direction; H: horizontal direction), so H, H+1˜H+8, H−1˜H−7, V, V+1˜V+8, V−1˜V−8 are used. Generally directional modes can be represented as either as H+k or V+k modes, where k=±1, ±2, . . . , ±8. (In some embodiments, intra-prediction mode has 65 directional modes so that the range of k is from ±1 to ±16.)

Out of the 35 intra-prediction modes in HEVC, 3 modes are considered as the most probable modes (MPM) for predicting the intra-prediction mode in current prediction block. These three modes are selected as an MPM set. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

In some embodiments, position dependent intra prediction combination (PDPC) is applied to some of the intra modes without signaling: planar, DC, horizontal, vertical, bottom-left angular mode and its x adjacent angular modes, and top-right angular mode and its x adjacent angular modes. The value x depends on the number of angular modes.

In some embodiments, multi-reference line intra prediction (MRLP) is used to improve the intra directional modes (i.e., direction modes of intra prediction) by increasing the number of the reference tiers for accuracy prediction. MRLP increases the number of the reference tiers from only one reference tier to N reference tiers for the intra directional modes, where N is larger than or equal to one.

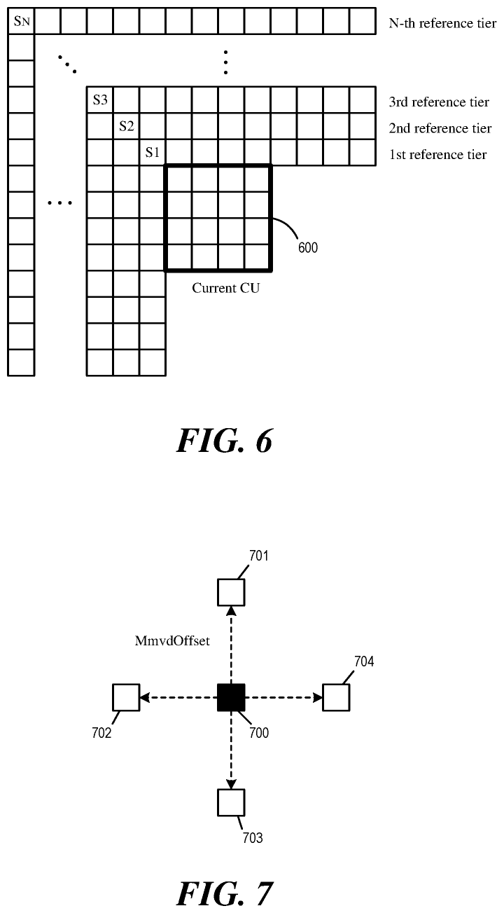

FIG. 6 conceptually illustrates multi-reference line intra prediction (MRLP) for an example 4×4 PU 600. Under MRLP, an intra directional mode could choose one of N reference tiers to generate the predictors. As illustrated, a predictor p(x, y) for the PU 600 is generated from one of the reference samples S₁, S₂, . . . , and S_{N} that are in reference tiers 1, 2, . . . N, respectively. In some embodiments, a flag is signaled (e.g., in a bitstream) to indicate which reference tier is chosen for an intra directional mode. If N is set as 1, only reference tier 1 is used, and the intra directional prediction method implemented is the same as the traditional method (i.e., without MRLP).

### III. Ultimate Motion Vector Expression (UMVE)

In some embodiments, ultimate motion vector expression (UMVE) is used for either skip or merge modes. UMVE is also referred to as Merge with Motion Vector Difference (MMVD). When a candidate is selected from among the merge candidates, the expression of the selected candidate is expanded under UMVE. UMVE provides a motion vector expression or function with simplified signaling. The UMVE motion vector expression includes prediction direction information, starting point, motion magnitude, and/or motion direction. For example, MMVD or UMVE may extend the candidates in the regular merge candidate list by applying a predefined offset (MmvdOffset) that is characterized by an absolute value of the offset (MmvdDistance) and a sign of the offset (MmvdSign). In other words, MMVD or UMVE is a coding mode or tool that modifies merge candidates by an offset, and the modified merge candidates are used to generate inter-prediction.

FIG. 7 illustrates extended merge candidate under MMVD or UMVE. The MMVD or UMVE extended candidates are derived by applying a motion vector expression or function to a merge candidate 700. The merge candidate 700 is a candidate from the regular merge candidate list. The motion vector expression or function applies a predefined offset to the merge candidate 700 to derive extended candidates 701-704.

In some embodiments, a merge candidate list is used as it is. However, candidates that are default merge type (MRG_TYPE_DEFAULT_N) are considered for UMVE's expansion. In UMVE expansion, the Prediction direction information indicates a prediction direction among L0, L1, and L0 and L1 predictions. In B slice, the bi-prediction candidates can be generated from merge candidates with uni-prediction by using mirroring technique. For example, if a merge candidate is uni-prediction with L1, a reference index of L0 is decided by searching a reference picture in list 0, which is mirrored with the reference picture for list 1. If there is no corresponding picture, the nearest reference picture to the current picture is used. L0′ MV is derived by scaling L1's MV. The scaling factor is calculated by picture order count (POC) distance.

If the prediction direction of the UMVE candidate is the same with one of the original merge candidates, the index with value 0 is signaled as an UMVE prediction direction. But, if not the same (same with one of the original merge candidates), the index with value 1 is signaled. After sending first bit, remaining prediction direction is signaled based on the pre-defined priority order of UMVE prediction direction. Priority order is L0/L1 prediction, L0 prediction and L1 prediction. If the prediction direction of merge candidate is L1, signaling ‘0’ is for UMVE' prediction direction L1. Signaling ‘10’ is for UMVE' prediction direction L0 and L1. Signaling ‘11’ is for UMVE' prediction direction L0. If L0 and L1 prediction lists are same, UMVE's prediction direction information is not signaled.

Base candidate index defines the starting point. Base candidate index indicates the best candidate among candidates in the list as follows or any subset of the candidates in the list as follows.

TABLE 1
Base candidate Index

| | | | | |
|---|---|---|---|---|
| Base candidate IDX | 0 | 1 | 2 | 3 |

Distance index specifies motion magnitude information and indicate the pre-defined offset from the starting point. As shown in FIG. 7, an offset is added to either horizontal component or vertical component of starting MV. The relation of distance index and pre-defined offset is specified as follows.

TABLE 2
Distance Index

| | Distance IDX | | | | | | | |
|---|---|---|---|---|---|---|---|---|
| | 0 | 1 | 2 | 3 | 4 | 5 | 6 | 7 |
| Pixel | ¼-pel | ½-pel | 1-pel | 2-pel | 4-pel | 8-pel | 16-pel | 32-pel |
| dis- | | | | | | | | |
| tance | | | | | | | | |

Direction index represents the direction of the MVD relative to the starting point. The direction index can represent of the four directions as shown below.

TABLE 3
Direction IDX

| Direction IDX | 00 | 01 | 10 | 11 |
|---|---|---|---|---|
| x-axis | + | − | N/A | N/A |
| y-axis | N/A | N/A | + | − |

In some embodiments, to reduce encoder complexity, block restriction is applied. For example, if either width or height of a CU is less than 4, UMVE is not performed.

### IV. Multi-Hypothesis Mode

In some embodiments, Multi-hypothesis mode is used to improve Inter prediction, which is an improved method for Skip and/or Merge modes. In original Skip and Merge mode, one Merge index is used to select one motion candidate, which may be either uni-prediction or bi-prediction derived by the candidate itself, from the Merge candidate list. The generated motion compensated predictor is referred to as the first hypothesis (or first prediction) in some embodiments. Under Multi-hypothesis mode, a second hypothesis is produced in addition to the first hypothesis. The second hypothesis of predictors can be generated by motion compensation from a motion candidate based on an inter prediction mode, (e.g., Merge or Skip modes), or by intra prediction based on an intra prediction mode.

When the second hypothesis (or second prediction) is generated by an Intra prediction mode, the Multi-hypothesis mode is referred to as MH mode for Intra or MH mode Intra or MH Intra or Inter-intra mode. (In other words, MH mode for Intra is a coding mode that modifies the inter-prediction by adding an intra-prediction.) When the second hypothesis is generated by motion compensation by a motion candidate or an inter prediction mode (e.g., Merge or Skip mode), the Multi-hypothesis mode is referred to as MH mode for Inter or MH mode Inter or MH Inter (or also called as MH mode for Merge or MH Merge).

For Multi-hypothesis mode, each Multi-hypothesis candidate (or called each candidate with Multi-hypothesis) contains one or more motion candidates (i.e., first hypothesis) and/or one intra prediction mode (i.e., second hypothesis), where the motion candidate are selected from a Candidate List I and/or the intra prediction mode is selected from a Candidate List II. For MH mode for intra, each Multi-hypothesis candidate (or called each candidate with Multi-hypothesis) contains one motion candidate and one Intra prediction mode, where the motion candidate is selected from Candidate List I and the intra prediction mode is selected from Candidate List II. MH mode for Inter uses two motion candidates and at least one of the two motion candidates selected from Candidate List I. In some embodiments, Candidate List I is identical to the Merge candidates list of the current block and that both motion candidates of a Multi-hypothesis candidate of MH mode for inter are selected from Candidate List I. In some embodiments, the Candidate List I is a subset of the Merge candidate list. In some embodiments, one of the motion candidates of a Multi-hypothesis candidate is selected from the Merge candidate list and another one of the motion candidates of the same Multi-hypothesis candidate is selected from Candidate List I.

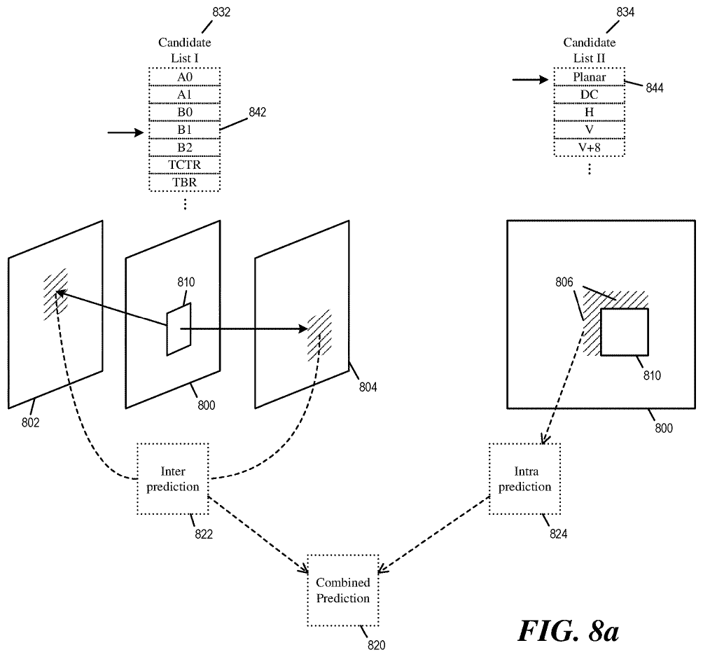

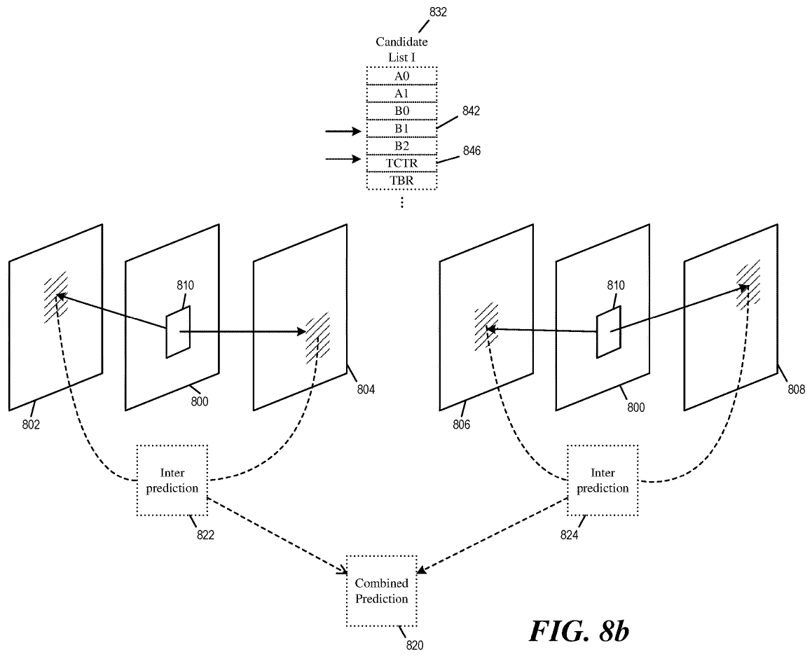

FIG. 8a conceptually illustrate encoding or decoding a block of pixels by using MH Mode for Intra. The figure illustrates a video picture 800 that is currently being encoded or decoded by a video coder. The video picture 800 includes a block of pixels 810 that is currently being encoded or decoded as a current block. The current block 810 is coded by MH mode for intra, specifically, a combined prediction 820 is generated based on a first prediction 822 (first hypothesis) of the current block 810 and a second prediction 824 (second hypothesis) of the current block 810. The combined prediction 820 is then used to reconstruct the current block 810.

The current block 810 being coded by using MH mode for Intra. Specifically, the first prediction is obtained by inter-prediction based on at least one of reference frames 802 and 804. The second prediction 824 is obtained by intra-prediction based on neighboring pixels 806 of the current block 810. As illustrated, the first prediction 822 is generated based on an inter-prediction mode or a motion candidate 842 that is selected from a first candidate list 832 (Candidate List I) comprising one or more candidate inter-prediction modes. The candidate list I can be the Merge candidate list of the current block 810. The second prediction 824 is generated based on an intra-prediction mode 844 that is selected from a second candidate list 834 (Candidate List II) comprising one or more candidate intra-prediction modes. If only one intra prediction mode (e.g. planar) is used for MH for intra, the intra prediction mode for MH for intra is set as that intra prediction mode without signaling.

FIG. 8b illustrates the current block 810 being coded by using MH mode for Inter. Specifically, the first prediction 822 is obtained by inter-prediction based on at least one of reference frames 802 and 804. The second prediction 824 is obtained by inter-prediction based on at least one of reference frames 806 and 808. As illustrated, the first prediction 822 is generated based on an inter-prediction mode or a motion candidate 842 (first prediction mode) that is selected from the first candidate list 832 (Candidate List I). The second prediction 824 is generated based on an inter-prediction mode or a motion candidate 846 that is also selected from the first candidate list 832 (Candidate List I). The candidate list I can be the Merge candidate list of the current block.

In some embodiments, when MH mode for Intra is supported, one flag is signaled (for example, to represent whether MH mode for Intra is applied) in addition to the original syntax for merge mode. Such a flag may be represented or indicated by a syntax element in a bitstream. In some embodiment, if the flag is on, one additional Intra mode index is signaled to indicate the Intra prediction mode from Candidate List II. In some embodiment, if the flag is on, the intra prediction mode for MH mode for intra is implicitly selected from Candidate List II or implicitly assigned with one intra prediction mode. In some embodiments, when the flag is off, MH mode for inter (e.g. TPM specified in section Triangular Prediction Unit Mode, or any one of other MH modes for inter which has different shapes of prediction units) can be used.

### V. Triangular Prediction Unit Mode (TPM)

In some embodiments, a video coder may use triangular partition mode or also called as triangular prediction unit mode (TPM) for motion compensated prediction. TPM splits a CU into two triangular prediction units, in either diagonal or inverse diagonal direction. Each triangular prediction unit in the CU is inter-predicted using its own uni-prediction motion vector and reference frame. An adaptive weighting process is performed at the diagonal edge between the two triangular prediction units after inter-prediction is performed for each of the two triangular prediction units. The transform and quantization process are applied to the whole CU. In some embodiments, TPM is applicable to only skip and merge modes.

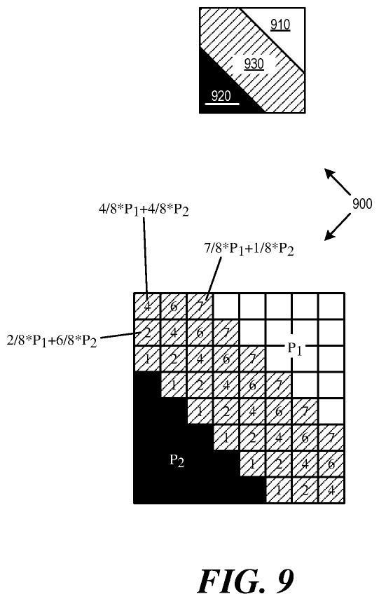

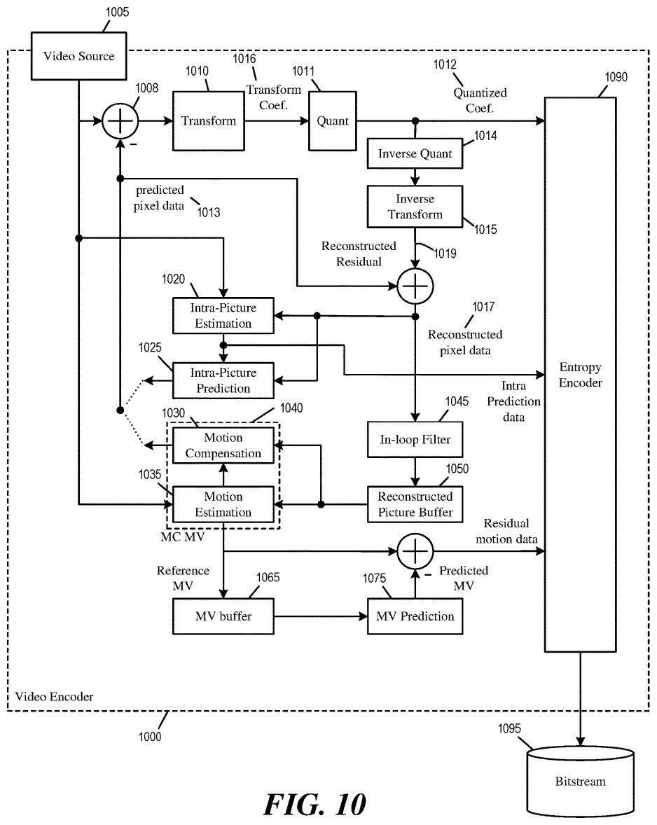

FIG. 9 conceptually illustrates a CU 900 that is coded by TPM. As illustrated, the CU 900 is divided into a first triangular region 910, a second triangular region 920, and a diagonal edge region 930. The first region 910 is coded by a first prediction (P₁). The second triangular region is coded by a second prediction (P₂). The diagonal edge region 930 is coded by weighted sum of the predictions from the first triangular region and second triangular region (e.g., ⅞*P₁+⅛*P₂). The weighting factors are different for different pixel positions. In some embodiments, P₁ is generated by inter prediction and P₂ is generated by intra prediction such that the diagonal edge region 930 is coded by MH mode for Intra. In some embodiments, P₁ is generated by a first inter prediction (e.g., based on a first MV or merge candidate) and P₂ is generated by a second inter prediction (e.g., based on a second MV or merge candidate) such that the diagonal edge region 930 is coded by MH mode for Inter. In other words, TPM is a coding mode that includes modifying an inter-prediction generated based on one merge candidate (P₁) by weighted sum with another inter-prediction that is generated based on another merge candidate (P₂).

### VI. Efficient Signaling of Different Coding Modes.

Some embodiments of the disclosure provide methods for efficiently signaling syntax elements for coding modes or tools. In some embodiments, a video codec (encoder or decoder) receives data for a block of pixels to be encoded or decoded as a current block of a current picture of a video. The video codec receives a first syntax element for a first coding mode in a particular set of two or more coding modes. Each of coding mode of the particular set of coding modes modifies a merge candidate or an inter-prediction that is generated based on the merge candidate. The video codec enables the first coding mode. The video codec also disables one or more other coding modes in the particular set of coding modes without signaling or parsing syntax elements for the disabled coding modes. In some embodiments, the one or more other coding modes in the particular set of coding modes are inferred to be disabled based on the first syntax element. In some embodiments, the first coding mode and the one or more other coding modes, which are inferred to be disabled while the first coding mode is enabled, can form the particular set or taken as the coding modes in the particular set explicitly or implicitly, which should not be limited in this disclosure. The video codec encodes or decodes the current block by using the enabled first coding mode and bypassing the disabled coding modes.

In some embodiment, in intra mode, when MRLP is applied, PCM mode is inferred to not be used. For example, if an index for representing a reference tier in MRLP mode is signaled, the syntax for PCM mode is signaled and PCM mode is inferred to not be used.

In some embodiments, in intra mode, the syntax for the MRLP is checked after the syntax for PCM mode. If the syntax for PCM mode indicates that PCM mode is used, intra prediction is not applied and the syntax for intra prediction, such as the syntax for MRLP is not signaled in the following; otherwise, intra prediction is applied and the syntax for intra prediction is signaled, for example, the reference tier, used in MRLP, is signaled and then the intra prediction mode is signaled.

In some embodiments, the candidates for generating the prediction for triangular prediction unit mode (TPM) or any one of other MH modes for inter cannot be Inter-intra (or MH mode for Intra). In some embodiments, when a flag for (enabling) Inter-intra is true (i.e., Inter-intra is applied), the syntax for TPM is not signaled and TPM is inferred to be disabled (based on the flag for Inter-intra). In some embodiments, the candidates for generating the prediction for MMVD cannot be Inter-intra (or MH mode for Intra). When the flag for Inter-intra is true (i.e., Inter-intra is applied or enabled), the syntax for MMVD is not to be signaled and MMVD is inferred to be disabled (based on the flag for Inter-intra). In another embodiment, the candidates for generating the prediction for Inter-intra cannot be MMVD. In some embodiments, when the flag for MMVD is true (i.e., MMVD is applied or enabled), the syntax for Inter-intra is not signaled and Intra-inter is inferred to be disabled (based on the MMVD flag). In some embodiment, the candidates for generating the prediction for TPM or any one of other MH modes for inter cannot be MMVD. One possible syntax design is that when the flag for MMVD is true (i.e., MMVD is applied or enabled), the syntax for TPM or any one of other MH modes for inter is not signaled and TPM is inferred to be disabled (based on the MMVD flag).

In some embodiments, the candidates for generating the prediction for TPM or any one of other MH modes for inter cannot be (derived from or provided by) MMVD or Inter-intra. In some embodiments, when the flag for MMVD or Inter-intra is true (i.e., MMVD or Inter-intra is applied or enabled), the syntax for TPM or any one of other MH modes for inter is not signaled and TPM or any one of other MH modes for inter is inferred to be disabled.

In some embodiments, when generating the intra prediction for Inter-intra (MH mode for Intra), the process (for generating the intra prediction) can be aligned with (e.g., identical to) that for normal intra mode. In some embodiment, when generating the intra prediction for Inter-intra, the process may be a different from that of normal intra mode, specifically, for operation simplification or complex reduction or intra buffer reduction. For example, PDPC is not used for the intra prediction of Inter-intra. With this setting, for some intra prediction modes such as DC, vertical, or horizontal modes, the size of intra prediction buffer may be reduced from the whole predicted block. For example, the size of intra prediction buffer for the current DC-predicted, vertical-predicted, or horizontal-predicted block can be reduced to one value, one line buffer with the length equal to the block width, or one line buffer with the length equal to the block height, respectively.

In some embodiments, MRLP is not used for the intra prediction of Inter-intra. When Inter-intra is applied, the reference tier is inferred to be the one particular reference tier without signaling. (The one particular reference tier may be the nearest reference tier for the current block.) In other words, the intra prediction of Inter-intra or MH mode for Intra is generated by using only one reference tier and no other reference tier. For example, in some embodiments, the particular reference tier may be inferred to be 1st reference tier for Inter-intra. For another example, the particular reference tier can be implicitly decided by the block width or block height or block size. In some embodiments, simplified MRLP is used for the inter prediction of Inter-intra. When Inter-intra is applied, the number (N) of candidate reference tiers is reduced to 1, 2, 3, or 4. For example, N is set to be 2 and the candidate reference tiers can be selected from {1^{st} 2^{nd}} reference tiers or can be selected from {1^{st}, 4th} reference tiers or can be implicitly decided to be selected from either {1st, 2nd} or {1st, 4th} reference tiers according to the block width or bock height or block size.

In some embodiments, the signaling for the intra prediction mode of Inter-intra is aligned with (e.g., identical or similar to) that for normal intra mode. In some embodiments, the signaling for the intra prediction mode of Inter-intra may include or use most probability mode (MPM) coding and equal probability coding. The MPM coding for Inter-intra may have its own context and the number (M) of MPM is different from that of normal intra mode (e.g., M is set to be 3). MPM generation may be similar to that of HEVC. One difference (between Inter-Intra and HEVC for MPM generation) is that when the intra prediction mode from the neighboring blocks is an angular prediction mode, the intra prediction mode is mapped to the horizontal or vertical mode depending on which mode is relatively nearing to the original intra prediction mode. Another difference is that MPM list for Inter-intra is filled up with {planar, DC, vertical, horizontal}, following this order.

For some embodiments, any combination of above can be applied to any tools or coding modes such as MRLP, Inter-intra, MMVD, TPM, any one of other MH modes for inter, or PCM. For example, a video codec (encoder or decoder) may receive a syntax element for one of a particular set of two or more coding modes that includes Inter-intra, MMVD, TPM, and any one of other MH modes for inter, which are coding modes that modify a merge candidate or an inter-prediction that is generated based on the merge candidate. The video codec enables the one coding mode indicated by the received syntax element while one or more other coding modes in the particular set of coding modes are inferred to be disabled without signaling or parsing syntax elements for the disabled coding modes.

Any of the foregoing proposed methods can be implemented in encoders and/or decoders. For example, any of the proposed methods can be implemented in an inter coding module or intra coding module of an encoder, a motion compensation module, a merge candidate derivation module of a decoder. Alternatively, any of the proposed methods can be implemented as a circuit coupled to the inter coding module or intra coding module of an encoder and/or motion compensation module, a merge candidate derivation module of the decoder.

### VII. Example Video Encoder

FIG. 10 illustrates an example video encoder 1000 that efficiently signal syntax element for coding modes or tools. As illustrated, the video encoder 1000 receives input video signal from a video source 1005 and encodes the signal into bitstream 1095. The video encoder 1000 has several components or modules for encoding the signal from the video source 1005, at least including some components selected from a transform module 1010, a quantization module 1011, an inverse quantization module 1014, an inverse transform module 1015, an intra-picture estimation module 1020, an intra-prediction module 1025, a motion compensation module 1030, a motion estimation module 1035, an in-loop filter 1045, a reconstructed picture buffer 1050, a MV buffer 1065, and a MV prediction module 1075, and an entropy encoder 1090. The motion compensation module 1030 and the motion estimation module 1035 are part of an inter-prediction module 1040.

In some embodiments, the modules 1010-1090 are modules of software instructions being executed by one or more processing units (e.g., a processor) of a computing device or electronic apparatus. In some embodiments, the modules 1010-1090 are modules of hardware circuits implemented by one or more integrated circuits (ICs) of an electronic apparatus. Though the modules 1010-1090 are illustrated as being separate modules, some of the modules can be combined into a single module.

The video source 1005 provides a raw video signal that presents pixel data of each video frame without compression. A subtractor 1008 computes the difference between the raw video pixel data of the video source 1005 and the predicted pixel data 1013 from the motion compensation module 1030 or intra-prediction module 1025. The transform module 1010 converts the difference (or the residual pixel data or residual signal 1009) into transform coefficients (e.g., by performing Discrete Cosine Transform, or DCT). The quantization module 1011 quantizes the transform coefficients into quantized data (or quantized coefficients) 1012, which is encoded into the bitstream 1095 by the entropy encoder 1090.

The inverse quantization module 1014 de-quantizes the quantized data (or quantized coefficients) 1012 to obtain transform coefficients, and the inverse transform module 1015 performs inverse transform on the transform coefficients to produce reconstructed residual 1019. The reconstructed residual 1019 is added with the predicted pixel data 1013 to produce reconstructed pixel data 1017. In some embodiments, the reconstructed pixel data 1017 is temporarily stored in a line buffer (not illustrated) for intra-picture prediction and spatial MV prediction. The reconstructed pixels are filtered by the in-loop filter 1045 and stored in the reconstructed picture buffer 1050. In some embodiments, the reconstructed picture buffer 1050 is a storage external to the video encoder 1000. In some embodiments, the reconstructed picture buffer 1050 is a storage internal to the video encoder 1000.

The intra-picture estimation module 1020 performs intra-prediction based on the reconstructed pixel data 1017 to produce intra prediction data. The intra-prediction data is provided to the entropy encoder 1090 to be encoded into bitstream 1095. The intra-prediction data is also used by the intra-prediction module 1025 to produce the predicted pixel data 1013.

The motion estimation module 1035 performs inter-prediction by producing MVs to reference pixel data of previously decoded frames stored in the reconstructed picture buffer 1050. These MVs are provided to the motion compensation module 1030 to produce predicted pixel data.

Instead of encoding the complete actual MVs in the bitstream, the video encoder 1000 uses MV prediction to generate predicted MVs, and the difference between the MVs used for motion compensation and the predicted MVs is encoded as residual motion data and stored in the bitstream 1095.

The MV prediction module 1075 generates the predicted MVs based on reference MVs that were generated for encoding previously video frames, i.e., the motion compensation MVs that were used to perform motion compensation. The MV prediction module 1075 retrieves reference MVs from previous video frames from the MV buffer 1065. The video encoder 1000 stores the MVs generated for the current video frame in the MV buffer 1065 as reference MVs for generating predicted MVs.

The MV prediction module 1075 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1095 by the entropy encoder 1090.

The entropy encoder 1090 encodes various parameters and data into the bitstream 1095 by using entropy-coding techniques such as context-adaptive binary arithmetic coding (CABAC) or Huffman encoding. The entropy encoder 1090 encodes various header elements, flags, along with the quantized transform coefficients 1012, and the residual motion data as syntax elements into the bitstream 1095. The bitstream 1095 is in turn stored in a storage device or transmitted to a decoder over a communications medium such as a network.

The in-loop filter 1045 performs filtering or smoothing operations on the reconstructed pixel data 1017 to reduce the artifacts of coding, particularly at boundaries of pixel blocks. In some embodiments, the filtering operation performed includes sample adaptive offset (SAO). In some embodiment, the filtering operations include adaptive loop filter (ALF).

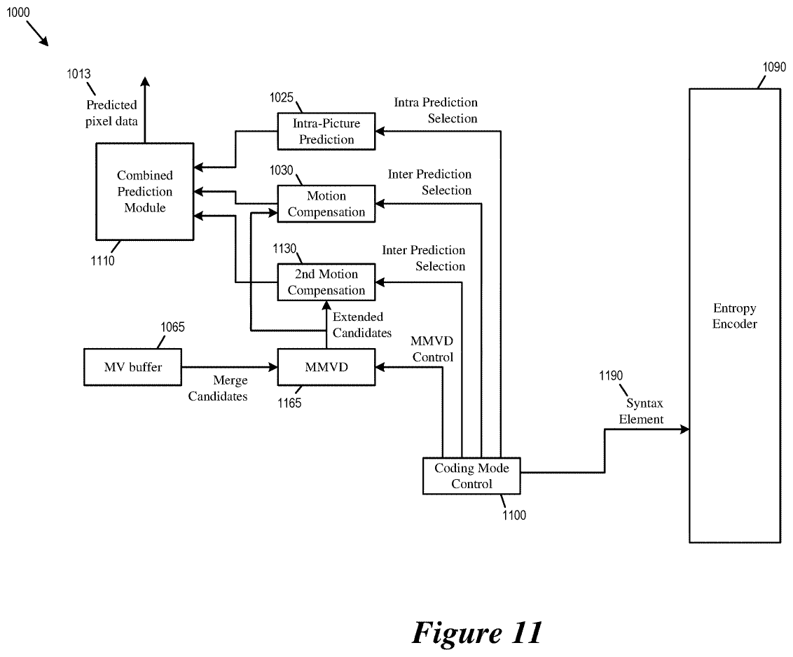

FIG. 11 illustrates portions of the video encoder 1000 that implement efficient signaling of coding modes or tools. As illustrated, the video encoder 1000 implements a combined prediction module 1110, which produces the predicted pixel data 1013. The combined prediction module 1110 may receive intra-prediction values generated by the intra-picture prediction module 1025. The combined prediction module 1110 may also receive inter-prediction values from the motion compensation module 1030, as well as a second motion compensation module 1130.

The MV buffer 1065 provides the merge candidates to the motion compensation modules 1030 and 1130. The merge candidates may be altered or extended by a MMVD or UMVE module 1165, which may apply a function to extend the merge candidates (e.g., by applying an offset to the merge candidates) so that the motion compensation module 1030 and 1130 may use the extended merge candidates. The extension of merge candidate is described in Section III above. The MV buffer 1065 also stores the motion information and the mode directions used to encode the current block for use by subsequent blocks.

A coding mode (or tool) control module 1100 controls the operations of the intra-picture prediction module 1025, the motion compensation module 1030, and the second motion compensation module 1130. The coding mode control module 1100 may enable the intra-prediction module 1025 and the motion compensation module 1030 to implement MH mode Intra (or Inter-Intra) mode. The coding mode control module 1100 may enable the motion compensation module 1030 and the second motion compensation module 1130 to implement MH mode Inter (e.g., for the diagonal edge region of TPM) mode. The coding mode control 1100 may enable the MMVD module 1165 to extend merge candidates to implement MMVD or UMVE mode. The coding mode control module 1100 determines which coding modes to enable and/or disable for coding the current block. The coding mode control module 1100 then controls the operations of the intra-picture prediction module 1025, the motion compensation module 1030, and/or the second motion compensation module 1130 to enable and/or disable specific coding modes.

In some embodiments, the coding mode control 1100 enables only a subset (one or more) of the coding modes from a particular set of two or more coding modes. In some embodiments, the particular set of two or more coding modes are tools that modify a merge candidate or an inter-prediction that is generated based on the merge candidate, such as MH Inter (e.g. TPM or any one of other MH modes for inter), MH intra, or MMVD. Thus, for example, if the MMVD is enabled, MH Inter and/or MH Intra modes are disabled. For another example, if MH Inter is enabled (e.g., for TPM), the MH Intra and/or MMVD modes are disabled. For another example, if MH Intra is enabled, MMVD and/or MH Inter modes are disabled.

The coding mode control 1100 generates or signals a syntax element 1190 to the entropy encoder 1090 to indicate that one or more than one of the coding modes are enabled. The video encoder 1000 also disables one or more other coding modes in the particular set of coding modes without signaling syntax elements for the disabled one or more other coding modes. In some embodiments, the one or more other coding modes in the particular set of coding modes are inferred to be disabled based on the syntax element 1190. For example, if a flag for enabling MMVD is signaled, MH Inter and/or MH Intra modes are inferred to be disabled without signaling syntax elements for MH Inter and/or MH Intra modes. For another example, if a flag for enabling MH Inter is signaled, MH Intra and/or MMVD modes are inferred to be disabled without signaling syntax elements for MH Inter and/or MH Intra modes. For example, if a flag for enabling MH Intra is signaled, MMVD and/or MH Inter modes are inferred to be disabled without signaling syntax elements for MMVD and/or MH Inter modes.

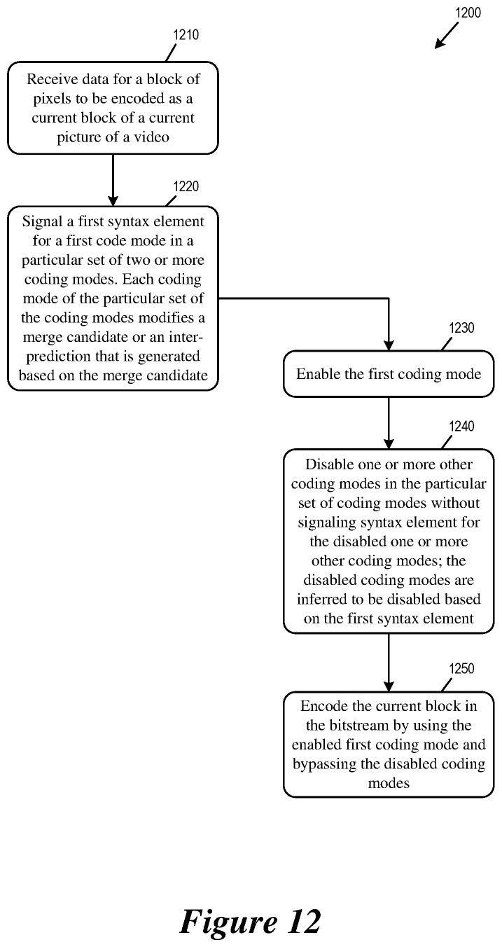

FIG. 12 conceptually illustrates a process 1200 for efficiently signaling syntax elements for coding modes or tools by a video encoder. In some embodiments, one or more processing units (e.g., a processor) of a computing device implementing the encoder 1000 performs the process 1200 by executing instructions stored in a computer readable medium. In some embodiments, an electronic apparatus implementing the encoder 1000 performs the process 1200.

The encoder 1000 receives (at step 1210) data for a block of pixels to be encoded as a current block of a current picture of a video. The encoder signals (at step 1220) a first syntax element in a bitstream for a first coding mode in a particular set of two or more coding modes. In some embodiments, each of the particular set of coding modes modifies a merge candidate or an inter-prediction that is generated based on the merge candidate.

The particular set of coding modes may include a coding mode such as MH mode intra that modifies the inter-prediction by adding an intra-prediction. The intra prediction is generated by using only one reference tier and no other reference tier (e.g., the intra-prediction is generated without using MRLP.) The particular set of coding modes may include a coding mode such as MMVD that modifies the merge candidate by an offset and the modified merge candidate is used to generate the inter-prediction. The particular set of coding modes may include a coding mode such as TPM or any other MH modes for inter that modifies the generated inter-prediction by weighted sum with another inter-prediction that is generated based on another merge candidate.

The encoder enables (at step 1230) the first coding mode. The encoder also disables (at step 1240) one or more other coding modes in the particular set of coding modes without signaling syntax elements for the disabled one or more other coding modes, (or at least a second coding mode in the particular set of coding modes is disabled without signaling a second syntax element for the second coding mode). In some embodiments, coding modes in the particular set of coding modes other than the first coding mode are inferred to be disabled based on the first syntax element.

The encoder encodes (at step 1250) the current block in the bitstream by using the enabled first coding mode and bypassing the disabled coding modes, e.g., by using the prediction generated based on the enabled coding modes to reconstruct the current block.

### VIII. Example Video Decoder

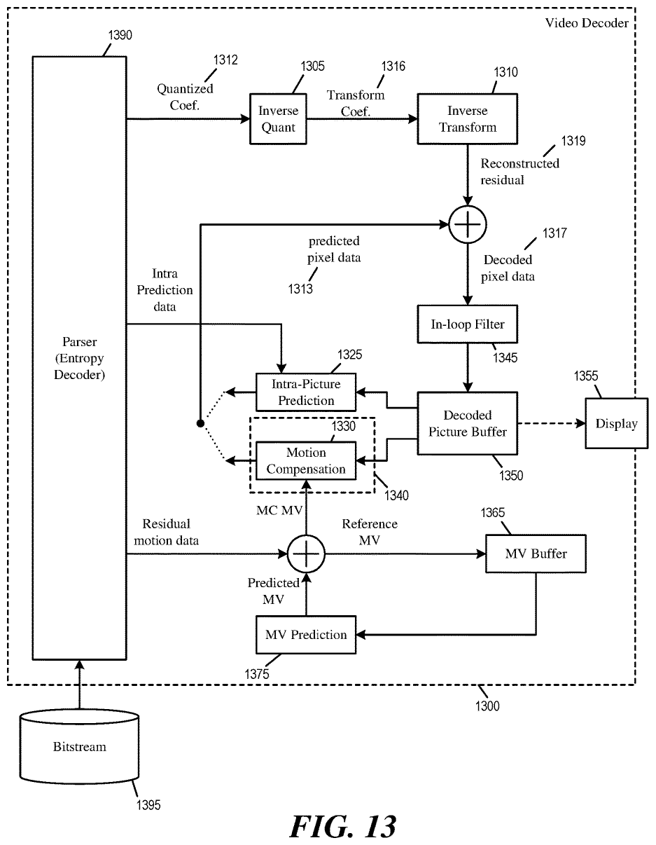

FIG. 13 illustrates an example video decoder 1300 that implement efficient signaling of coding modes or tools. As illustrated, the video decoder 1300 is an image-decoding or video-decoding circuit that receives a bitstream 1395 and decodes the content of the bitstream into pixel data of video frames for display. The video decoder 1300 has several components or modules for decoding the bitstream 1395, including some components selected from an inverse quantization module 1305, an inverse transform module 1310, an intra-prediction module 1325, a motion compensation module 1330, an in-loop filter 1345, a decoded picture buffer 1350, a MV buffer 1365, a MV prediction module 1375, and a parser 1390. The motion compensation module 1330 is part of an inter-prediction module 1340.

In some embodiments, the modules 1310-1390 are modules of software instructions being executed by one or more processing units (e.g., a processor) of a computing device. In some embodiments, the modules 1310-1390 are modules of hardware circuits implemented by one or more ICs of an electronic apparatus. Though the modules 1310-1390 are illustrated as being separate modules, some of the modules can be combined into a single module.

The parser 1390 (or entropy decoder) receives the bitstream 1395 and performs initial parsing according to the syntax defined by a video-coding or image-coding standard. The parsed syntax element includes various header elements, flags, as well as quantized data (or quantized coefficients) 1312. The parser 1390 parses out the various syntax elements by using entropy-coding techniques such as context-adaptive binary arithmetic coding (CABAC) or Huffman encoding.

The inverse quantization module 1305 de-quantizes the quantized data (or quantized coefficients) 1312 to obtain transform coefficients, and the inverse transform module 1310 performs inverse transform on the transform coefficients 1316 to produce reconstructed residual signal 1319. The reconstructed residual signal 1319 is added with predicted pixel data 1313 from the intra-prediction module 1325 or the motion compensation module 1330 to produce decoded pixel data 1317. The decoded pixels data are filtered by the in-loop filter 1345 and stored in the decoded picture buffer 1350. In some embodiments, the decoded picture buffer 1350 is a storage external to the video decoder 1300. In some embodiments, the decoded picture buffer 1350 is a storage internal to the video decoder 1300.

The intra-prediction module 1325 receives intra-prediction data from bitstream 1395 and according to which, produces the predicted pixel data 1313 from the decoded pixel data 1317 stored in the decoded picture buffer 1350. In some embodiments, the decoded pixel data 1317 is also stored in a line buffer (not illustrated) for intra-picture prediction and spatial MV prediction.

In some embodiments, the content of the decoded picture buffer 1350 is used for display. A display device 1355 either retrieves the content of the decoded picture buffer 1350 for display directly, or retrieves the content of the decoded picture buffer to a display buffer. In some embodiments, the display device receives pixel values from the decoded picture buffer 1350 through a pixel transport.

The motion compensation module 1330 produces predicted pixel data 1313 from the decoded pixel data 1317 stored in the decoded picture buffer 1350 according to motion compensation MVs (MC MVs). These motion compensation MVs are decoded by adding the residual motion data received from the bitstream 1395 with predicted MVs received from the MV prediction module 1375.

The MV prediction module 1375 generates the predicted MVs based on reference MVs that were generated for decoding previous video frames, e.g., the motion compensation MVs that were used to perform motion compensation. The MV prediction module 1375 retrieves the reference MVs of previous video frames from the MV buffer 1365. The video decoder 1300 stores the motion compensation MVs generated for decoding the current video frame in the MV buffer 1365 as reference MVs for producing predicted MVs.

The in-loop filter 1345 performs filtering or smoothing operations on the decoded pixel data 1317 to reduce the artifacts of coding, particularly at boundaries of pixel blocks. In some embodiments, the filtering operation performed includes sample adaptive offset (SAO). In some embodiment, the filtering operations include adaptive loop filter (ALF).

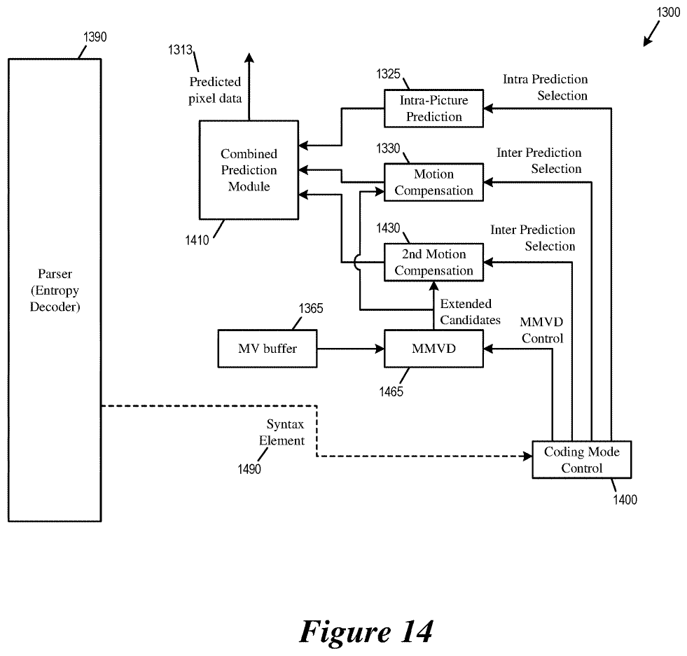

FIG. 14 illustrates portions of the video decoder 1300 that implement efficient signaling of coding modes or tools. As illustrated, the video decoder 1300 implements a combined prediction module 1410, which produces the predicted pixel data 1313. The combined prediction module 1410 may receive intra-prediction values generated by the intra-picture prediction module 1325. The combined prediction module 1410 may also receive inter-prediction values from the motion compensation module 1330, as well as a second motion compensation module 1430.

The MV buffer 1365 provides the merge candidates to the motion compensation modules 1330 and 1430. The merge candidates may be altered or extended by a MMVD or UMVE module 1465, which may apply a function to extend the merge candidates (e.g., by applying an offset to the merge candidates) so that the motion compensation module 1330 and 1430 may use the extended merge candidates. The extension of merge candidate is described in Section III above. The MV buffer 1365 also stores the motion information and the mode directions used to decode the current block for use by subsequent blocks.

A coding mode (or tool) control module 1400 controls the operations of the intra-picture prediction module 1325, the motion compensation module 1330, and the second motion compensation module 1430. The coding mode control module 1400 may enable the intra-prediction module 1325 and the motion compensation module 1330 to implement MH mode Intra (or Inter-Intra) mode. The coding mode control module 1400 may enable the motion compensation module 1330 and the second motion compensation module 1430 to implement MH mode Inter (e.g., for the diagonal edge region of TPM) mode. The coding mode control 1400 may enable the MMVD module 1465 to extend merge candidates to implement MMVD or UMVE mode. Based on syntax element 1490 parsed from entropy decoder 1390, the coding mode control module 1400 determines which coding modes to enable and/or disable for coding the current block. The coding mode control module 1400 then controls the operations of the intra-picture prediction module 1325, the motion compensation module 1330, and/or the second motion compensation module 1430 to enable and/or disable specific coding modes.

In some embodiments, the coding mode control 1400 enables only a subset (one or more) of the coding modes from a particular set of two or more coding modes. In some embodiments, the particular set of two or more coding modes are tools that modify a merge candidate or an inter-prediction that is generated based on the merge candidate, such as MH Inter (e.g. TPM or any one of other MH modes for inter), MH intra, or MMVD. Thus, for example, if the MMVD is enabled, MH Inter and/or MH Intra modes are disabled. For another example, if MH Inter is enabled (e.g., for TPM), the MH Intra and/or MMVD modes are disabled. For another example, if MH Intra is enabled, MMVD and/or MH Inter modes are disabled.

The coding mode control 1400 parses or receives a syntax element 1490 from the entropy decoder 1390 to enable one or more coding modes. Based on this received syntax element 1490, the video decoder 1300 also disables one or more other coding modes in the particular set of coding modes without parsing syntax elements for the disabled one or more other coding modes. In some embodiments, the one or more other coding modes in the particular set of coding modes are inferred to be disabled based on the received syntax element 1490. For example, if a flag for enabling MMVD is parsed, MH Inter and/or MH Intra modes are inferred to be disabled without syntax elements for MH Inter and/or MH Intra modes. For another example, if a flag for enabling MH Inter is parsed, MH Intra and MMVD modes are inferred to be disabled without syntax elements for MH Inter and/or MH Intra modes. For another example, if a flag for enabling MH Intra is parsed, MMVD and/or MH Inter modes are inferred to be disabled without syntax elements for MMVD and/or MH Inter modes.

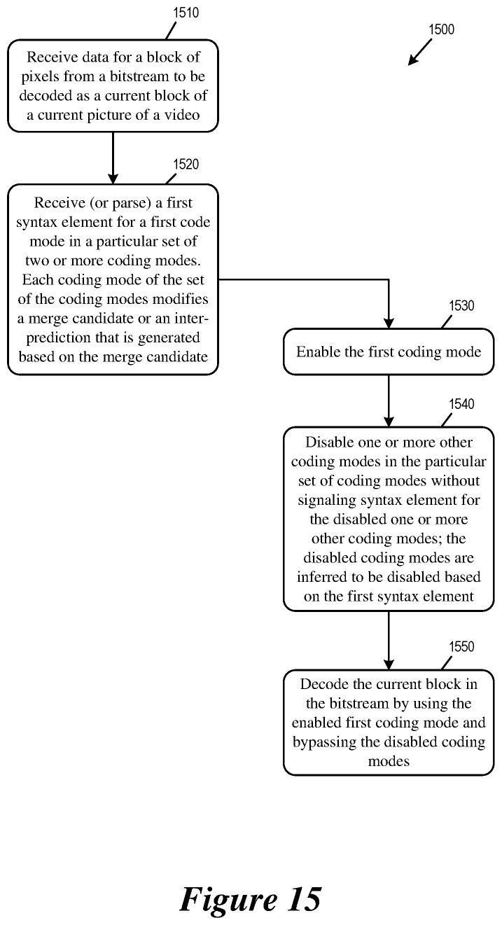

FIG. 15 conceptually illustrates a process 1500 for efficiently signaling syntax elements for coding modes or tools by a video decoder. In some embodiments, one or more processing units (e.g., a processor) of a computing device implementing the decoder 1300 performs the process 1500 by executing instructions stored in a computer readable medium. In some embodiments, an electronic apparatus implementing the decoder 1300 performs the process 1500.

The decoder 1300 receives (at step 1510) data for a block of pixels to be decoded as a current block of a current picture of a video. The decoder receives (at step 1520) or parses a first syntax element in a bitstream for a first coding mode in a particular set of two or more coding modes. In some embodiments, each of the particular set of coding modes modifies a merge candidate or an inter-prediction that is generated based on the merge candidate.

The particular set of coding modes may include a coding mode such as MH mode intra that modifies the inter-prediction by adding an intra-prediction. The intra prediction is generated by using only one reference tier and no other reference tier (e.g., the intra-prediction is generated without using MRLP.) The particular set of coding modes may include a coding mode such as MMVD that modifies the merge candidate by an offset and the modified merge candidate is used to generate the inter-prediction. The particular set of coding modes may include a coding mode such as TPM or any other MH modes for inter that modifies the generated inter-prediction by weighted sum with another inter-prediction that is generated based on another merge candidate.

The decoder enables (at step 1530) the first coding mode. The decoder also disables (at step 1540) one or more other coding modes in the particular set of coding modes without signaling syntax elements for the disabled one or more other coding modes, (or at least a second coding mode in the particular set of coding modes is disabled without signaling a second syntax element for the second coding mode). In some embodiments, coding modes in the particular set of coding modes other than the first coding mode are inferred to be disabled based on the first syntax element.

The decoder decodes (at step 1550) the current block in the bitstream by using the enabled first coding mode and bypassing the disabled coding modes, e.g., by using the prediction generated based on the enabled coding modes to reconstruct the current block.

### IX. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

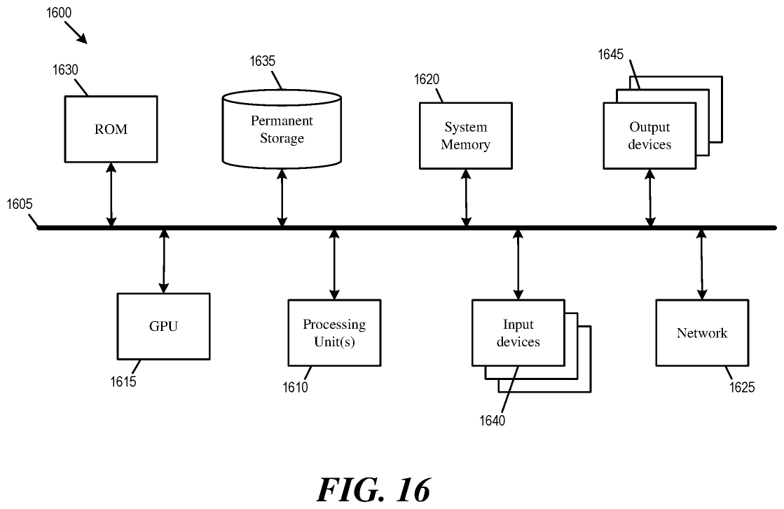

FIG. 16 conceptually illustrates an electronic system 1600 with which some embodiments of the present disclosure are implemented. The electronic system 1600 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1600 includes a bus 1605, processing unit(s) 1610, a graphics-processing unit (GPU) 1615, a system memory 1620, a network 1625, a read-only memory 1630, a permanent storage device 1635, input devices 1640, and output devices 1645.

The bus 1605 collectively represents all system, peripheral, and chipset buses that communicatively connect the numerous internal devices of the electronic system 1600. For instance, the bus 1605 communicatively connects the processing unit(s) 1610 with the GPU 1615, the read-only memory 1630, the system memory 1620, and the permanent storage device 1635.

From these various memory units, the processing unit(s) 1610 retrieves instructions to execute and data to process in order to execute the processes of the present disclosure. The processing unit(s) may be a single processor or a multi-core processor in different embodiments. Some instructions are passed to and executed by the GPU 1615. The GPU 1615 can offload various computations or complement the image processing provided by the processing unit(s) 1610.

The read-only-memory (ROM) 1630 stores static data and instructions that are used by the processing unit(s) 1610 and other modules of the electronic system. The permanent storage device 1635, on the other hand, is a read-and-write memory device. This device is a non-volatile memory unit that stores instructions and data even when the electronic system 1600 is off. Some embodiments of the present disclosure use a mass-storage device (such as a magnetic or optical disk and its corresponding disk drive) as the permanent storage device 1635.

Other embodiments use a removable storage device (such as a floppy disk, flash memory device, etc., and its corresponding disk drive) as the permanent storage device. Like the permanent storage device 1635, the system memory 1620 is a read-and-write memory device. However, unlike storage device 1635, the system memory 1620 is a volatile read-and-write memory, such a random access memory. The system memory 1620 stores some of the instructions and data that the processor uses at runtime. In some embodiments, processes in accordance with the present disclosure are stored in the system memory 1620, the permanent storage device 1635, and/or the read-only memory 1630. For example, the various memory units include instructions for processing multimedia clips in accordance with some embodiments. From these various memory units, the processing unit(s) 1610 retrieves instructions to execute and data to process in order to execute the processes of some embodiments.

The bus 1605 also connects to the input and output devices 1640 and 1645. The input devices 1640 enable the user to communicate information and select commands to the electronic system. The input devices 1640 include alphanumeric keyboards and pointing devices (also called “cursor control devices”), cameras (e.g., webcams), microphones or similar devices for receiving voice commands, etc. The output devices 1645 display images generated by the electronic system or otherwise output data. The output devices 1645 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 16, bus 1605 also couples electronic system 1600 to a network 1625 through a network adapter (not shown). In this manner, the computer can be a part of a network of computers (such as a local area network (“LAN”), a wide area network (“WAN”), or an Intranet, or a network of networks, such as the Internet. Any or all components of electronic system 1600 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIGS. 12 and 15) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An electronic apparatus, comprising:
a video decoder circuit configured to perform operations comprising:
receiving data for a block of pixels from a bitstream to be decoded as a current block of a current picture of a video, the data including a first syntax element to indicate whether multiple-hypothesis (MH) mode is enabled for the current block;
generating a first hypothesis of prediction for the current block using a first candidate;
in response to the first syntax indicating that the MH mode is enabled for the current block,
determining a second candidate according to a parsed second syntax element;
generating a second hypothesis of prediction for the current block using the second candidate;
combining the first and second hypotheses of prediction to form a combined prediction; and
decoding the current block using the first hypothesis of prediction or a combined prediction;
wherein the first candidate refers to a first inter merge candidate selected from a merge candidate list,
in response to determining the second candidate as an intra prediction mode, the intra prediction mode is inferred as planar without signaling, and
in response to determining the second candidate as a second inter merge candidate, the second inter merge candidate is selected from a subset of the merge candidate list.

2. A video coding method, comprising:
receiving data for a block of pixels from a bitstream to be decoded as a current block of a current picture of a video, the data including a first syntax element to indicate whether multiple-hypothesis (MH) mode is enabled for the current block;
generating a first hypothesis of prediction for the current block using a first candidate;
in response to the first syntax indicating that the MH mode is enabled for the current block,
determining a second candidate according to a parsed second syntax element;
generating a second hypothesis of prediction for the current block using the second candidate;
combining the first and second hypotheses of prediction to form a combined prediction; and
decoding the current block using the first hypothesis of prediction or a combined prediction;
wherein the first candidate refers to a first inter merge candidate selected from a merge candidate list,
in response to determining the second candidate as an intra prediction mode, the intra prediction mode is inferred as planar without signaling, and
in response to determining the second candidate as a second inter merge candidate, the second inter merge candidate is selected from a subset of the merge candidate list.

3. An electronic apparatus, comprising:
a video encoder circuit configured to perform operations comprising:
determining data for a block of pixels to be encoded as a current block of a current picture of a video, the data including a first syntax element to indicate whether multiple-hypothesis (MH) mode is enabled for the current block;
generating a first hypothesis of prediction for the current block using a first candidate;
in response to the first syntax indicating that the MH mode is enabled for the current block,
determining a second candidate according to a second syntax element to be signaled;
generating a second hypothesis of prediction for the current block using the second candidate;
combining the first and second hypotheses of prediction to form a combined prediction; and
encoding the current block using the first hypothesis of prediction or a combined prediction;
wherein the first candidate refers to a first inter merge candidate selected from a merge candidate list,
in response to determining the second candidate as an intra prediction mode, the intra prediction mode is inferred as planar without signaling, and
in response to determining the second candidate as a second inter merge candidate, the second inter merge candidate is selected from a subset of the merge candidate list.
